(19) United States
(12) Patent Application Publication
(10) Pub. No.: US 2020/0335318 A1
(43) Pub. Date: Oct. 22, 2020

(54) SYSTEM FOR TRANSFERRING IONS TO A MASS SPECTROMETER

(71) Applicant: 1st Detect Corporation, Webster, TX (US)

(72) Inventors: Jan Hendrikse, Whitby (CA); John Daniel DeBord, Houston, TX (US); Stephen Davila, Pearland, TX (US); Offie Lee Drennan, League City, TX (US)

(21) Appl. No.: 16/097,661

(22) PCT Filed: Jan. 31, 2018
(86) PCT No.: PCT/US2018/016157

§ 371 Date: Oct. 30, 2018

Related U.S. Application Data
(60) Provisional application No. 62/452,659, filed on Jan. 31, 2017.

(51) Int. Cl. H01J 49/16; H01J 49/04

(52) U.S. Cl. CPC H01J 49/167; H01J 49/045; H01J 49/049

(57) ABSTRACT

The present disclosure relates to systems and methods for transferring ions to a mass spectrometer. In one implementation, the system includes an ion source; a device for generating a solvent vapor; a unit for mixing the ions and the vapor; and a transfer tube coupled to the mass spectrometer. The mixing may cause solvent clusters to nucleate on the ions, and the transfer tube may couple the ion source and the mass spectrometer. Furthermore, the transfer tube may be configured to transfer the ions by using a gas flow and prevent the solvent clusters from contacting the tube wall by using thermophoresis.

### CROSS-REFERENCE TO RELATED APPLICATION

This application claims priority to U.S. Provisional Application No. 62/452,659, filed Jan. 31, 2017, the entire contents of which are incorporated herein.

### TECHNICAL FIELD

The present disclosure relates to a systems and methods for transferring ions. More specifically, and without limitation, the present disclosure relates to systems and methods for transferring ions along a transfer tube to a mass spectrometer.

### BACKGROUND

Fieldable mass spectrometers are often used to take chemical analyses that used to be done in the lab and perform them in situ on site. Ideally, such instruments can analyze samples in real time, using a probe that can be pointed at or scanned across a surface of interest. This may be achieved by combining a portable mass spectrometer with a hand-held ionization and sample collection probe. For example, mass spectrometer may be located on a desk or in a rucksack carried by the operator, reactant ions are created locally inside the probe tip, and analyte ions—ions that are formed when the reactant ions react with any sample molecules present—may be carried through a tube by the gas flow from the probe to the mass spectrometer. This so-called “transfer tube” generally has to be long enough to give the operator sufficient range of motion to scan surfaces for compounds of interest. An ideal range of motion may be achieved, for example, if the transfer tube is at least 100 cm long.

Commercial probes, such as low temperature plasma (LTP), Direct Analysis in Real Time (DART) and Desorption Electrospray Ionization (DESI), typically experience significant ion losses inside the tube, often up to 99%. These losses typically increase with the length of the tube. Minimization of ion losses (maximizing transfer efficiency) is a key indicator of performance of the probe. In practice, ions are mostly lost to the tube walls; once the ions have lost their charge, they cannot be detected by the mass spectrometer.

The use of a stainless steel transfer tube using a DART ion source has been attempted. Such an arrangement increases the transfer efficiencies for positive ions but not for negative ions. A second type of solution may depend on maintaining a laminar flow in the transfer tube. Maintaining laminar flow may help reduce the mixing resulting from turbulent flow that increases ion losses to the tube wall. The conditions under which turbulence occurs can be estimated theoretically using the well-known Reynolds number Re, which may be defined according to Equation 1 below.

Re=vDₕ/V Equation 1

In the example of Equation 1, V is the linear speed of the gas in m/s, Dₕ is the hydraulic diameter of the tube, which is equal to the geometric diameter for tubes with a circular cross section, and v is the kinematic viscosity in m²/s. Laminar flow occurs when Re is approximately less than 2300, and turbulent flow occurs when Re is approximately greater than 4000. In the interval between 2300 and 4000, both laminar and turbulent flows are possible and are called “transition” flows. Whether laminar or turbulent flows develop depends on other factors, such as pipe roughness and flow uniformity.

The mass flow along the length of the tube is generally constant, but as the gas expands while it is moving through the tube, its speed V increases to maintain constant mass flow. Because the kinematic viscosity v in Equation 1 is generally close to constant as a function of pressure, Re tends to increase as the gas moves down the transfer tube. As a result, the flow may be laminar at the high pressure inlet end of the tube and still be turbulent at the low pressure end. Accordingly, the pressure difference along the length of the transfer tube should be kept small to make sure the flow is laminar. However, it is not always practical for the pressure difference to remain small. Thus, it is not always practical to maintain laminar flow, and there is thus a need for a design that decreases ion losses while sustaining turbulent flow.

### BRIEF DESCRIPTION OF DRAWINGS

FIG. 1 is a schematic representation of the components of an exemplary system for transferring ions to a mass spectrometer.

FIG. 2A is a schematic representation of an exemplary system for transferring ions to a mass spectrometer.

FIG. 2B is a graphical representation of the pressure of the gas in the exemplary system of FIG. 2A.

FIG. 2C is a graphical representation of the temperature of the gas in the exemplary system of FIG. 2A.

FIG. 3A is a graphical representation of the temperature as a function of distance in the exemplary system of FIG. 2A.

FIG. 3B is a graphical representation of the thermophoretic force as a function of distance in the exemplary system of FIG. 2A.

FIG. 4A is a schematic representation of an exemplary heater for the exemplary system of FIG. 2A.

FIG. 4B is a schematic representation of an exemplary tubing for the exemplary system of FIG. 2A.

FIG. 4C is a schematic representation of an example of the components used in the exemplary system of FIG. 2A.

FIG. 5 is a schematic representation of an exemplary ion source for the exemplary system of FIG. 2A.

### SUMMARY

In one embodiment of the present disclosure, a system for transferring ions to a mass spectrometer may comprise an ion source; a device for generating a solvent vapor; and a transfer tube coupled to the mass spectrometer. The mixing may cause solvent clusters to nucleate on the ions, and the transfer tube may couple the ion source and the mass spectrometer. The transfer tube may further be conFig.d to transfer the ions by using a gas flow and to prevent the solvent clusters from contacting the tube wall by using thermophoresis.

In one embodiment, the system may further comprise a heater located at the end of the transfer tube. The heater may liberate the ions from the solvent clusters.

In any of the embodiments above, the ion source may include at least one of: atmospheric-pressure chemical ionization, low-temperature plasma ionization, dielectric barrier discharge, and flowing atmospheric-pressure afterglow.

In any of the embodiments above, the solvent may have a permanent dipole moment equal or greater than the dipole moment of water.

In any of the embodiments above, the transfer tube may be further conFig.d to allow the gas to expansively cool as it flows through the transfer tube and thereby create a temperature gradient for the thermophoresis.

In any of the embodiments above, the transfer tube may be further conFig.d to cause the gas to expand before entering the tube. In such an embodiment, the expansive cooling of the gas may occur in a substantially straight section of tubing. Additionally or alternatively, the system may further comprise a nozzle located before the transfer tube and conFig.d to cause the gas to expand before entering the tube. The nozzle may comprise at least one of: a diverging nozzle or a converging-diverging nozzle.

In any of the embodiments above, the walls of the transfer tube may be heated. In such an embodiment, the walls of the transfer tube wall may be heated to increasing temperatures from the ion source to the mass spectrometer.

In any of the embodiments above, the transfer tube may include one or more curves. In such an embodiment, the walls of the transfer tube before and after the one or more curves may be heated.

In any of the embodiments above, the ion source, the solvent vapor generating device, and the mixing unit may include at least one of: an electrospray ionization (ESI) source, or a paper spray ionization source.

In any of the embodiments above, the ion source, the solvent vapor generating device, and the mixing unit comprise at least one of: an Extractive ESI (EESI) source, a Desorption ESI (DESI) source, or a Laser Ablation ESI (LAESI) source.

In any of the embodiments above, the mixing unit may include a diverging nozzle. Additionally or alternatively, the mixing unit may include a section of constant diameter tubing conFig.d to cause the solvent clusters to nucleate on the ions. In such an embodiment, the constant diameter tubing may have a diameter smaller than the diameter of the transfer tube and/or the nucleation may occur along at least a portion of the length of the transfer tube.

In any of the embodiments above, the solvent vapor generating device may comprise a sintered metal wick in contact with a solvent reservoir. In such an embodiment, the wick may be located at the end of the inlet to the transfer tube or may be located near the middle of the inlet to the transfer tube, where the pressure is below atmosphere. Additionally or alternatively, the solvent vapor generating device may evaporate the solvent by heating the wick.

In any of the embodiments above, the gas flow may become turbulent in at least part of the transfer tube.

In any of the embodiments above, the transfer tube may be between 20 cm and 100 cm long.

In another embodiment of the present disclosure, a system for the transfer of ions may comprise an ion source for generating ions; an aerosol generating device for generating aerosol; a unit for mixing the ions and the aerosol; and a transfer tube. The mixing may cause charged aerosol clusters to form, and the transfer tube may couple the ion source and a destination for the ions. The transfer tube may be conFig.d to transfer the ions by using a gas flow and prevent the charged aerosol clusters from contacting the tube wall by using thermophoresis.

In one embodiment, the aerosol generating device may comprise an ultrasonic nebulizer. Additionally or alternatively, the aerosol generating device may generate aerosol using a Venturi effect.

### DETAILED DESCRIPTION

In extant probes, ion losses to the transfer tube wall have four general causes: diffusion of the ions, migration of the ions due to space charge effects, radial mixing of the gas flow due to Dean secondary flow (vortex) effects in tube bends and radial mixing due to turbulence of the gas flow. Losses from diffusion and migration may be lessened (and possibly minimized) by keeping the transfer time through the tube low, e.g., by using a high gas flow rate, while losses from radial mixing may be lessened (and possibly minimized) by maintaining low flow rates, leading to contradicting requirements. Embodiments of the present disclosure may lessen (and possibly minimize) ion losses despite these contradictory flow requirements by encapsulating ions in clusters or small droplets and using a thermophoretic force to push the encapsulated ions away from the tube wall. (As used herein, the terms “cluster,” “droplet” and “particle” are interchangeable.) Ions encapsulated in a solvent cluster have a lower diffusion coefficient and mobility. As a result, losses due to diffusion and space charge will be at least somewhat reduced.

Furthermore, when droplets of sufficient size, e.g., a few tens of nm radius, are placed in a gas having a temperature gradient, they become subject to thermophoretic forces, i.e., gas molecules hitting the droplet from the hot direction have more energy than droplets hitting the droplet from the opposite, cold direction, resulting in a net force directed towards the cold side of the droplet. Thus, these droplets have a tendency to move against a thermal gradient ΔT with a thermophoretic speed Vₜₕ, which may be defined by Equation 2 below.

Vₜₕ=−vKₜₕ/T\vec{Δ}T Equation 2

In the example of Equation 2, v is the kinematic viscosity of the gas, T is the temperature of the gas, and Kₜₕ is the thermophoretic coefficient. For the small neutral particles described herein, Kₜₕ generally approaches a value of 0.55. When the tube wall is a few tens of Kelvin warmer than the gas, the thermophoretic force may be large enough to overcome the diffusion towards the tube wall for particles as small as, for example, a few tens of nm in diameter. As a result, essentially (e.g., less than 10%) no particles reach the tube wall. The variation of radial particle thermophoretic and diffusional velocities in the radial direction in a tube with a wall that is heated to various temperatures may be theoretically calculated.

Accordingly, by ensuring that the tube wall is warmer than the gas stream at every point along the transfer tube, droplets may be kept away from the tube wall for an indefinite amount of time. For example, it may be possible to achieve a transfer efficiency >90% for a 1 m long tube heated to a uniform temperature along its length. Extant engineering curves and equations may be used to calculate the temperature difference between the tube wall and the gas flow entering the tube needed to achieve a theoretical transmission efficiency of 99.96%. However, even a smaller efficiency (e.g., on the order of 30%) represents a significant improvement over the current transfer efficiencies in extant probes, which generally are in the single digit percent range. Moreover, the required temperature difference between tube wall and gas flow may be estimated for zero particle deposition in a circular tube air flow.

However, maintaining the ideal wall temperature along the entire length of the tube is not trivial: For example, if the wall is not sufficiently warm, the thermophoretic effect will not be strong enough, and the droplets will drift to the wall. On the other hand, if the wall temperature is too high, the droplets may evaporate, and the thermophoretic effect will be lost altogether. Accordingly, the present disclosure describes a system having a wall temperature that slowly rises in a direction towards the mass spectrometer. In some embodiments, this effect may be achieved by placing a plurality of independently controlled heaters along the length of the tube. In other embodiments, a single heater wire wound with non-uniform speed may be used. Other variations on these embodiments may be implemented by one of ordinary skill. Tubes according to the present disclosure may outperform most extant tubes in terms of transmission efficiency.

According to the present disclosure, the transfer efficiency of the disclosed system may be independent of radial mixing due to turbulence and depend only on the presence of a non-turbulent boundary layer close to the tube wall. As the droplets diffuse towards the wall but are pushed away from it by the thermophoretic effect, their concentration profile across the tube diameter becomes similar to the profile under perfect radial mixing as particles are lost to the wall. The particle concentration profile near the wall is changed into more parabolic shape along the dimensionless axial coordinate Z. In contrast, when the tube wall temperature is higher than the inlet gas temperature, the concentration profile has a much steeper slope near the wall and does not change very much in the axial direction. In such embodiments, the particle concentration drops close to the wall because particles are pushed away by the thermophoretic force, not because they are lost to the wall.

Advantageously, this may permit gas flowing down the tube to travel at a speed close to the speed of sound, and, as a result, the corresponding high Reynolds numbers will cause turbulence at the low pressure side of the transfer tube. Embodiments of the present disclosure may therefore allow for turbulence, unlike many extant probes.

Similarly, ion losses due to radial mixing in curved parts of the tube due to secondary (Dean) flow may be reduced or eliminated in the disclosed system. Dean flow is known to make a significant contribution to heat and mass exchange in helical tubes, but this effect is generally unwanted in transfer tubes. In curved tubes, the magnitude of mass (and heat) exchange between the tube wall and the gas flow may be described by the Schmidt (and Nusselt) numbers and may increase with the Dean number, De, which may be defined according to Equation 3 below.

De=Re*sprt(dᵢ/dᵣ) Equation 3

In the example of Equation 3, Re is the Reynolds number as defined in Equation 1 above, dᵢ is the hydraulic diameter of the tube, and dᵣ is the diameter of curvature.

When the thermophoretic force is used to counteract the centripetal force in the Dean vortex, the gas flow in the tube may be run at higher Dean numbers. This may provide at least three advantages. First, the flow may run at higher Reynolds numbers, i.e., at higher flow rates, such that the acceptable flow rate may be limited neither by turbulence nor by the formation of Dean vortexes. Second, wider tubes with larger dᵢ may be used if needed. Third, the tubes may be flexible (and may thus have curves with a smaller radius dᵣ), allowing the sampling probe more freedom of movement.

In some embodiments, the transfer tube may require fixed curves, for example, in places where it connects to the probe or to the instrument. In such embodiments, the effects of Dean vortex mixing may be reduced by heating the outer wall of the curve very locally, e.g., immediately upstream and in the curve. As a result, power consumption and evaporative droplet loss may be reduced or even eliminated.

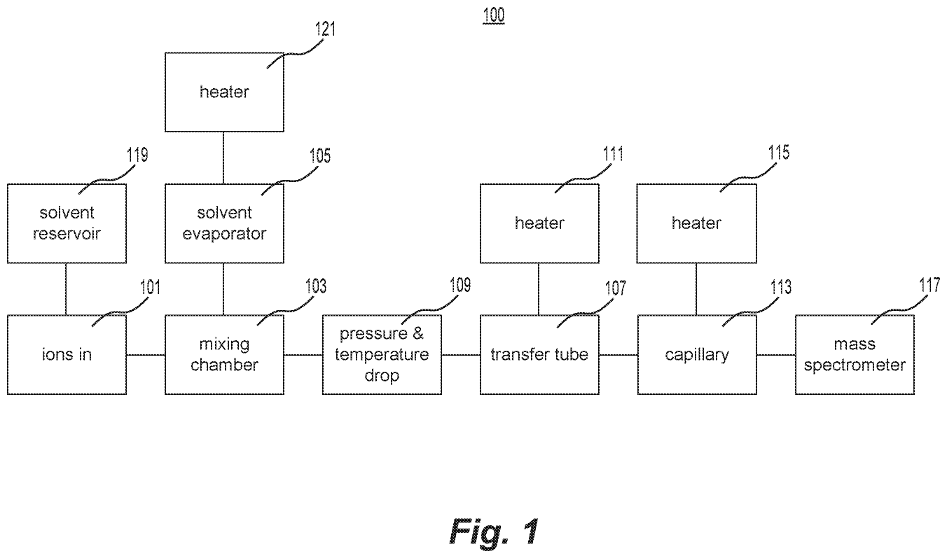

FIG. 1 is a schematic representation of the components of an exemplary system 100 for transferring ions to a mass spectrometer. As depicted in FIG. 1, ions generated by an ion source may be entrained in a gas stream 101 and enter a chamber 103. In the chamber, the ions may be mixed with a solvent vapor. The solvent vapor may be generated inside an evaporator 105. After the gas expands after the mixing chamber 103, the corresponding temperature drop may aid the solvent molecules in forming droplets having ions as their nucleus. Droplets move down the tube 107 and may be kept away from the tube wall by the thermophoretic force. The temperature difference needed to generate a thermophoretic force may be generated by the cooling of the gas as it expands (e.g., the pressure and temperature drop 109) in tube 107, heating (e.g., with heater 111) of the transfer tube wall, or a combination thereof. The ions may be liberated from their droplet by a sharp increase in temperature in the heated (e.g., with heater 115) capillary 113 before the ions enter the mass spectrometer 117. The heated capillary 113 of FIG. 1 may be widened and/or shortened to reduce its flow resistance, such that the overall flow is the same as that of a standard capillary.

In the example of FIG. 1, the gas expands and cools as it travels down the tube 107, which may generate a temperature difference between the tube wall and the gas. This expansion may be generated using adiabatic flow down a short, narrow piece of tubing with constant diameter (taking friction losses within the gas and against the tube wall into account), using frictionless adiabatic flow through an expanding nozzle or a combination thereof. Flow in expanding nozzles taking friction and heat exchange with the environment into account may be modeled numerically, but does not alter the principles described herein. A prototype using a short and narrow tube may be easier to design, and since it is followed by a gradual increase in tube diameter tube where the gas expands, the two options tend to produce similar results.

As a real (i.e., non-ideal) gas expands while it is travelling down a capillary from atmosphere to a lower pressure, the work done by the gas reduces its temperature. For gas inlet speeds that are much smaller than the speed of sound (e.g., M≈0) and for outlet speeds equal to or near the speed of sound (i.e., M≈1), the temperature of the gas at the exit may be approximately 83% of the inlet temperature. For example, a gas flowing into the tube at 298K may exit at 248K. However, when the gas flows through a tube of any length, most of the expansion and, accordingly, most of the temperature drop of the gas may occur very close to the outlet end. Preferably, a thermophoretic effect is generated along the entire length of the tube. Accordingly, a pressure drop at the inlet side may be useful. In some embodiments, this additional pressure drop may be created by adding a short narrow restrictor tube or nozzle at the inlet side, followed by a wider transfer tube. This additional pressure drop may also aid the encapsulation of ions into clusters.

Since the flow resistance of the tube scales with the diameter to the fourth power, the diameter differences do not need to be very big to create large differences in resistance. For example, a restrictor with a diameter of 0.3 mm and a length of 29 mm may be used with a transfer tube with a diameter of 1 mm and a length of 1000 mm. In such an embodiment, the pressure and temperature drop rapidly as the gas flows through the restrictor, and the temperature of the gas is accordingly reduced as it begins to flow through the transfer tube. However, in such an embodiment, most of the expansion and temperature drop of the gas may occur at the end of the restrictor capillary, which makes the temperature and pressure drop very sensitive to small variations in the design.

The Mach number at the outlet side may be defined according to Equation 4 below.

$$4 fL \text{/} {D}_{H} = \frac{1}{γ} ( \frac{2}{{M}_{1}^{2}} - \frac{1}{{M}_{2}^{2}} ) + \frac{γ + 1}{2 γ} ln \frac{{M}_{1}^{2}}{{M}_{2}^{2}} ( \frac{\begin{matrix}1 + \\ \frac{γ + 1}{2} {M}_{2}^{2}\end{matrix}}{\begin{matrix}1 - \\ \frac{γ - 1}{2} {M}_{1}^{2}\end{matrix}} ) \qquad Equation 4$$

In the example of Equation 4, L is the tube length, γ is the compressibility factor of the gas (e.g., equal to 1.4 for air), M₁ and M₂ are the Mach numbers at the inlet and outlet of the tube, D_{H} is the diameter of the tube, and f is the friction factor of the tube. The friction factor may be defined according to Equation 5 below.

$$f = \frac{64}{Re} for laminar flow ( Re < 2500 ) \\ f = \frac{\begin{matrix}0.24 \; 79 - 9.47 E - 5 \cdot \\ {( 7 - log ( Re ) )}^{4}\end{matrix}}{{[ log ( \begin{matrix}\frac{e}{3.615 D} + \\ \frac{7.366}{{Re}^{09142}}\end{matrix} ) ]}^{2}} for turbulent flow ( Re > 250 \; 0 ) \qquad Equation 5$$

In the example of Equation 5, e is the surface roughness of the inner wall of the tube.

The pressure and temperature drop within the tub may be defined according to Equations 6 and 7 below (using, for example, γₐᵢᵣ=1.4).

$$\begin{matrix}{T}_{1} \text{/} {T}_{2} = 1 + 0.2 {M}_{2}^{2} \text{/} 1 + 0.2 {M}_{1}^{2} & Equation 6 \\ {P}_{1} \text{/} {P}_{2} = \frac{{M}_{2}}{{M}_{1}} \sqrt{1 + 0.2 {M}_{2}^{2} \text{/} 1 + 0.2 {M}_{1}^{2}} & Equation 7\end{matrix}$$

The Mach number generally cannot be calculated explicitly and, instead, may be found iteratively. The friction factor at the tube inlet was used in the calculations below. Although the Reynolds number and friction factor at the tube outlet may differ considerably from this value, they may only start to differ close to the end of the tube and therefore may only have a large impact on the friction factor averaged over the length of the tube. A full solution of the partial differential equation taking this into account indicates more gentle pressure and temperature profiles along the length of the tube. Accordingly, the results presented in the present disclosure are valid as long as the mean free path of the gas molecules is much smaller than the tube diameter, i.e. the Knudsen number <<1. This is generally the case, even at the low pressure side of the tube. For many combinations of parameters, the flow may become turbulent at the end of the tube with Re>4500. For a thermophoretic transfer tube, this does not present a problem.

In some embodiments, the gas may additionally or alternatively be cooled by moving through a divergent or convergent-divergent nozzle, for example, a Laval nozzle. These nozzles generally create rapid and well-defined expansions where the gas rapidly reaches supersonic speeds and cools down very fast, so that very high oversaturation levels can be reached, resulting in very efficient cluster formation. However, as discussed in more detail below, high oversaturation levels may reduce the efficiency of the disclosed system. Moreover, it is preferable to avoid the shock wave that necessarily follows when a gas slows to M<1. Accordingly, a design that functions at subsonic speeds may be preferred.

In some embodiments, a combination of at least two of tube heating, adiabatic flow, and the use of a divergent or convergent-divergent nozzle may be incorporated.

The calculations on the relationship between transfer efficiency and temperature difference discussed previously assumed incompressible flow in a tube with a constant wall temperature, (e.g., a very conductive wall). In some embodiments including the short restrictor and/or evaporator at the high pressure end of the transfer tube, and having a heated capillary at its low pressure end, the pressure drop along its length may be minimal such that the gas flow may be treated as incompressible. In a less conductive embodiment, e.g., if the tube comprises a flexible polymer tube that is not very conductive, the temperature may not be constant along its length. Accordingly, gas may have cooled relative to the ambient temperature, but the outside of the tube wall may remain at ambient temperature. The amount of heat that diffuses to the inside of the tube depends on the wall thickness and thermal conductivity of the tube material, while the amount of heat removed by convective transport away from the tube wall depends on the gas flow rate and tube inner diameter. This is a heat flow problem described by the Nusselt number.

Accordingly, the transfer tube described herein may be formed of a material with optimal resistance to heat flow through the tube. For example, if the tube is highly conductive, the gas may heat rapidly as it flows down the tube, and the thermophoretic effect may be lost when the gas temperature reaches the ambient temperature. On the other hand, if the tube is a perfect insulator, the temperature of the gas may stay at its lowest value, such that no temperature profile develops in the radial direction, thereby eliminating the thermophoretic effect. Thus, the optimal resistance may be between the resistance at which the thermophoretic effect may be lost and the resistance at which a temperature profile may not develop in the radial direction.

After the ions and vapor are mixed in the mixing chamber 103 in FIG. 1, the pressure and temperature of the gas drops such that the ions form the nuclei for the formation of small droplets. Nozzles for the creation of well-defined cluster sizes and densities have been extensively studied, and one of ordinary skill may apply any appropriate design rules for the homogeneous nucleation of neutral clusters. Heterogeneous nucleation on ions generally occurs much more readily than homogeneous nucleation. Accordingly, ions often may be encapsulated into droplets by merely exposing them to a solvent vapor. Moreover, ions may function as sites for heterogeneous nucleation in a vapor, even when the vapor concentration is too low for the formation of droplets in the absence of ions.

For example, if a 100 sccm gas flow containing 1000 ppm of solvent is sufficient for droplet formation, the solvent consumption may be approximately 160 nl/min for a methanol solvent. Accordingly, a system constructed according to this example may run continuously for over a week on only 2 ml of methanol solvent. By way of further example, a 20 nm diameter droplet may have a volume of only <10⁻²⁰ I, so to capture 100,000 ions per second into droplets, only 10⁻⁹ ml/min of solvent may be required. Moreover, in an example where solvent evaporation is used to cool the air by 30K, 64 nl/s of methanol is needed, or, 2 ml per 8 hour shift.

When small uncharged droplets form from their vapor, energy is gained by condensation, but energy may also be needed to form the droplet surface. Accordingly, the equilibrium pressure of the vapor over a droplet depends on its radius. The equilibrium pressure may be defined according to Equation 8a below.

$$- k T ln \frac{p}{{p}_{s a t}} + \frac{2 σ M}{{N}_{A} ρ r} = 0 \qquad Equation 8 a$$

In the example of Equation 8a, p is the vapor pressure of the solvent vapor, r is the radius of the droplet and pₛₐₜ is the gas saturation vapor pressure over the flat surface of the solvent (i.e., as r→∞). σ is the surface tension of the solvent, and ρ is the bulk density of the solvent. In the example of Equation 8a, the second left hand term is always positive, so p/pₛₐₜ is >1 for all r. Accordingly, an overpressure may be needed for the nucleation of droplets of any size and, at small overpressures, r* should be quite large. For neutral vapor molecules, the Kelvin equation tends to fit experimental data fairly well, but when, as in some embodiments of the present disclosure, vapor molecules attach to ions, the resulting charged droplet is in equilibrium with a much smaller vapor pressure than the pressure derived from Equation 8a. As a result, it may be easy to form the small droplets needed for thermophoresis.

Moreover, the presence of a charge on a droplet tends to diminish the evaporation tendency of the droplet. The electrostatic potential energy of the droplet increases as the droplet evaporates, and more work has to be available to evaporate a charged droplet than a neutral one. Accounting for the evaporation tendency of the droplet, the equilibrium pressure may be defined according to Equation 8b below.

kT ln^{p}/pₛₐₜ=2σM/N_{A}ρr−(qe)²M/32π²ε₀N_{A}ρr⁴(1−1/εₗ) Equation 8b

In the example of Equation 8b, M is the molar mass of the solvent, and qe is the charge of the ion. ε₀ is the (relative) permittivity of vacuum, and εₗ is the (relative) permittivity of the liquid. The first term on the right is the same as in the example of Equation 8a. Accordingly, droplets may nucleate more readily on ions than on neutral particles.

In some embodiments, the disclosed system may form small ion clusters with vapor molecules using, for example, H₂O, NH₃, CH3OH, and C5H5N. In such embodiments, the enthalpy values may be up to 20 kcal/mol more negative than enthalpy values for neutral clusters. This effect depends on the dipole moment of the neutral vapor molecules, as shown in Equation 9 below.

kT ln^{p}/pₛₐₜ=surface tension+charge+dipole 1+dipole 2, where

surface tension=2σM/N_{Aρr′}

charge=−(qe)^{M/}32π²ε₀N_{A}ρr⁴(1−1/εₗ)′

dipole1=−a(qe)²M/32π²ε₀r⁴, and

dipole2=kT ln[exp(B)−exp(−B)/2B] with B=μ₀qe/4πε₀r²kT. Equation 9

In the example of Equation 9, α is the polarizability, and μ₀ is the permanent dipole moment of the solvent. Together, the charge and two dipole related terms are, in many cases, larger than the first surface tension term such that the right hand side of the equation becomes negative, and droplets may form at partial pressures below Pₛₐₜ. Charged particles usually need an oversaturation of 1.5 in order to be stable while neutral particles may need an oversaturation of 4. Between these values, nucleation will only take place on charged particles, which will tend to grow at the expense of neutral particles of the same size. Accordingly, fewer and larger droplets may form that each contain an ion. This result may be preferred because the thermophoretic force increases with the droplet size.

In examples having saturation values over 4, both ions and neutral molecules may function as nucleation sites, generally leading to more and smaller droplets, only some of which contain an ion. For thermophoresis, nucleation on ions only may be preferred. Accordingly, rapid expansions, like those occurring in Laval nozzles, may be avoided since the resulting temperature drop may increase the oversaturation to a level such that unwanted nucleation on neutral particles may occur. Additionally or alternatively, embodiments of the present disclosure may use a solvent with a high dipole moment. For example, acetonitrile may be used. Alternatively, water may be used and may cause fewer environmental issues.

In addition, solvent transport to the ion may further improve if the vapor molecules have a large dipole moment. When a positive or negative ion approaches a neutral molecule with a permanent dipole moment (e.g., water), the two may be attracted over distances that are several atom radii. The increase in reaction rate caused by this attraction may be defined according to Equation 10 below.

k=(2πq/\sqrt{μ})[\sqrt{α}++Cμ_{D}\sqrt{2/πkT}] Equation 10

In the example of Equation 10, q is the charge of the ion, μ is the reduced mass of the reactants, α is the polarizability, and μ_{D} the permanent dipole moment of the neutral. The dipole locking constant C generally has a value between 0.5 and 1. For example, Equation 10 predicts that Acetonitrile molecules (i.e., α=4.29E-24 cm³ and μ=3.828 D) interacting with H₃O⁺ ions has an increased reaction rate of three times.

As further depicted in FIG. 1, ions may be exposed to the solvent molecules by transferring the solvent from a reservoir 119 to the evaporator 105 and mixing the vapor in the mixing chamber 103. For example, evaporator 105 may comprise a metal sintered wick positioned at the entrance of the transfer tube 107. As the solvent evaporates, the wicking action may replace the solvent lost with solvent from the reservoir 119 without using mechanical pumps or any moving parts. This may result in enhanced distribution of the liquid on the wick surface, increase in the effective surface area, and replacement of the solvent through capillary pumping, removing the need for an external pump. In some examples, a sintered wick was used with heat pipes having outer diameters of 3, 4 and 5 mm. In the example with a heat pipe having an outer diameter of 3 mm, the inner diameter was approximately 1/16 inches. In these examples, the heat pipes cost approx. 12 USD a piece and may be used to make 3-5 wicks.

For example, the disclosed system may use methanol, whose standard enthalpy of vaporization is 38.278 kJ/mol=1.19 kJ/g=0.94 kJ/ml. Accordingly, to evaporate 160 nl/min of methanol, less than 1 μW may be needed. Most extant sintered metal wicks have more than sufficient capacity at this rate.

In some embodiments, a heater 121 may be added to the evaporation side of the wick. As a result, the flow rate may be modulated by changing the wick temperature. For example, when the instrument is in stand-by mode, the wick heater and gas flow through the transfer tube may be turned off in order to limit fluid consumption. By way of further example, the temperature during this process may be controlled using pulse width modulated heating.

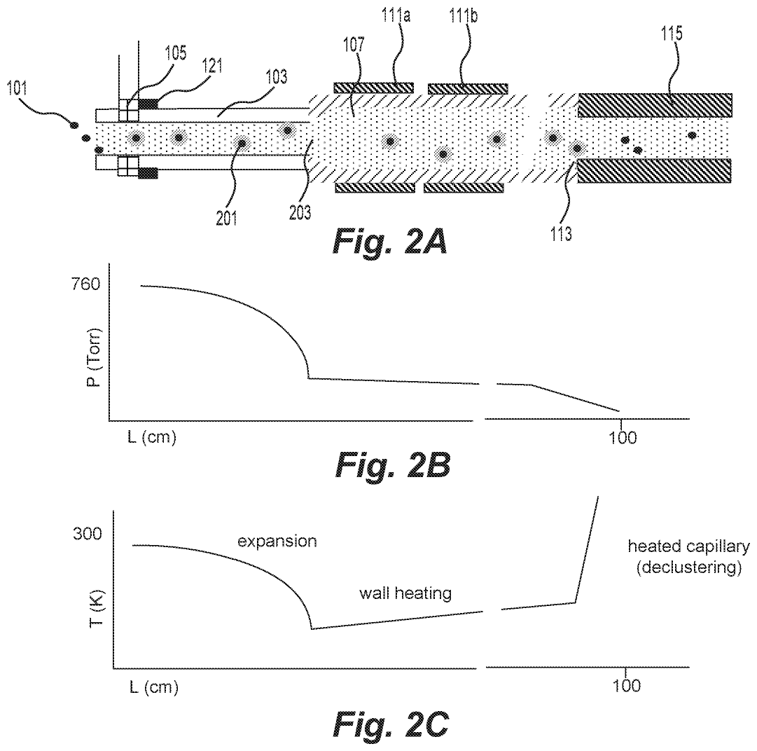

FIG. 2A shows a schematic representation of an exemplary system for transferring ions to a mass spectrometer. Not all design elements are necessary for the functioning of the assembly under all circumstances, and assemblies missing one or several of the elements shown here may still function as a thermophoretic transfer tube. For example, some ion sources create encapsulated ions; if such ion sources are used, the solvent mixing chamber, solvent evaporation, solvent reservoir, and/or solvent heater may be omitted.

As depicted in FIG. 2A, a gas stream containing bare ions 101 may enter a mixing chamber 103. A solvent may enter the same chamber through an evaporator 105, for example, a sintered wick. In this example, the solvent may evaporate inside the wick and turns into vapor. In some embodiments, vaporization may be increased by including a heater 121 placed in thermal contact with the evaporator 105. The solvent vapor molecules may mix with the ions and form clusters 201, where typically the ions 101 form the nucleus of the cluster.

FIG. 2B is a graphical representation of the pressure of the gas in the exemplary system of FIG. 2A, and FIG. 2C is a graphical representation of the temperature of the gas in the exemplary system of FIG. 2A. For example, when the gas flow enters the tube assembly, initially the pressure drop may be moderate because the inner diameter of the wick and mixing area may be relatively wide, e.g., on the order of 1/16 inches. When the gas reaches a diverging nozzle (e.g., nozzle 203 as depicted in FIG. 2A), it may expand rapidly such that its pressure and temperature drop. The temperature drop may increase the oversaturation of the vapor, aiding in nucleation of solvent clusters on the ions. The system of FIG. 2A may include a divergent nozzle shaped to control nucleation and growth of clusters in a specific way.

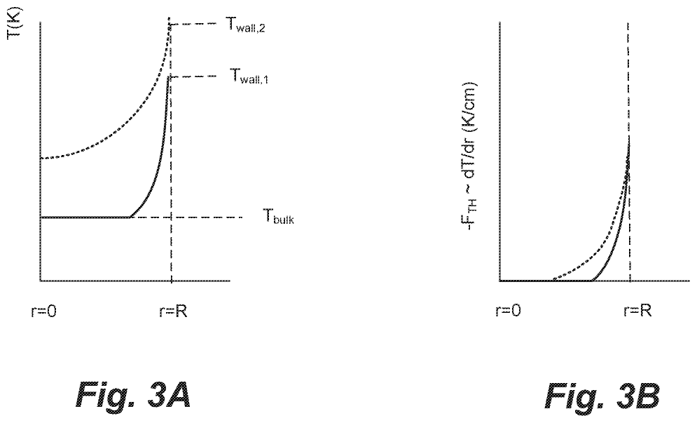

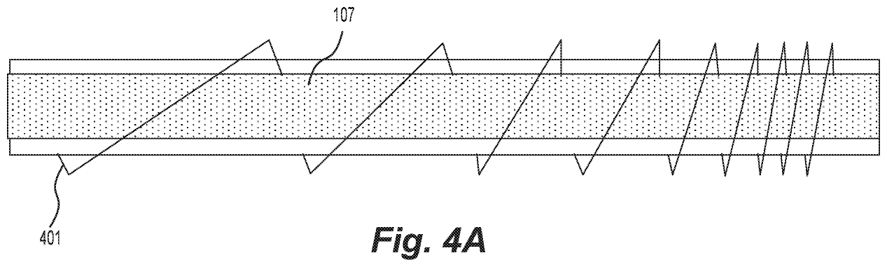

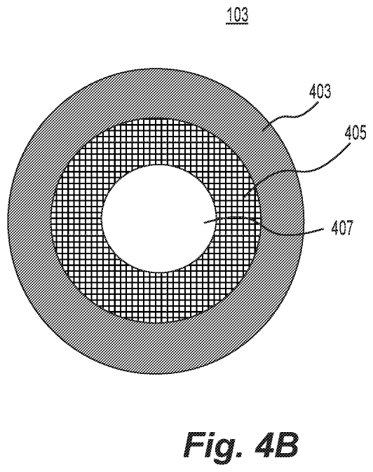

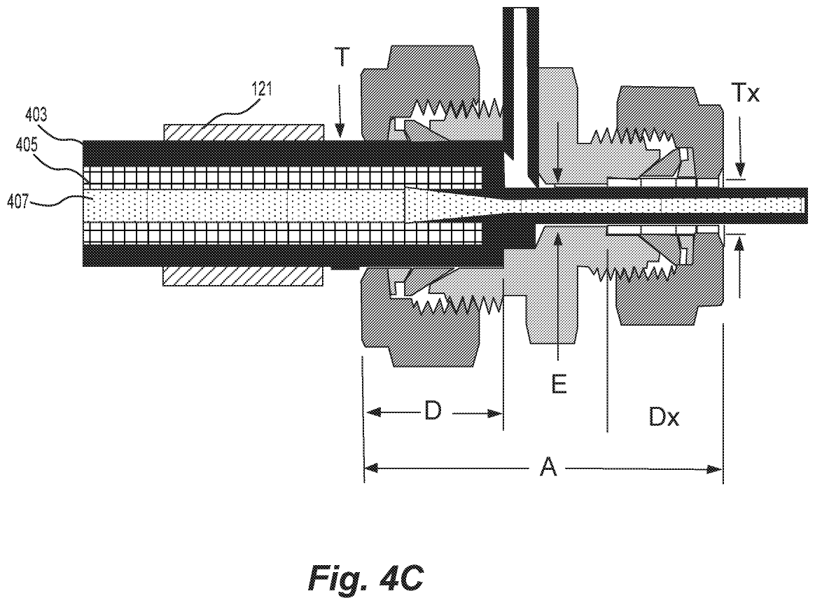

As further depicted in FIG. 2A, ion clusters may move into the transfer tube 107 where heaters (e.g., heaters 111a and 111b) along the tube heat its wall to create a radial temperature gradient between the tube wall and the gas flow. The solid curve in FIG. 3A is a graphical representation of the temperature as a function of distance in the exemplary system of FIG. 2A, and the solid curve FIG. 3B is a graphical representation of the thermophoretic force a function of distance in the exemplary system of FIG. 2A. Because the transfer tube may be wider than the neck of the divergent nozzle 203, the bulk gas temperature may increase modestly as the gas moves down the transfer tube. As the gas temperature approaches the wall temperature, the thermophoretic effect is lost. Accordingly, the wall temperature may be high enough to create sufficient thermophoretic effect while remaining below Tₑᵥ in order to avoid evaporation of the clusters. In some embodiments, this optimal temperature may be achieved by including a plurality of heaters (e.g., heaters 111a and 111b) along the length of the tube, each heater operating at a slightly different temperature, such that the difference between wall and bulk gas temperature, T_{wall}−T_{bulk}, remains approximately constant as a function of L, as illustrated by the dashed curves in FIGS. 3A and 3B. Before the clusters 201 enter the mass spectrometer vacuum (not depicted in FIG. 2A), the clusters 201 may pass through a capillary 113 including a heater 115 at a high temperature typical for heated inlet capillaries. Accordingly, the solvent molecules may evaporate such that the mass spectrometer may measure the mass of the naked ion. In some embodiments, the wall temperature may be varied along the length of the tube by using a single heater wire 401 that is wound around the transfer tube 107 with a varying speed. The wall temperature may be higher where the heater wire 401 is wound with slower speed. FIG. 4A depicts such a heater.

In some embodiments, the mixing chamber (e.g., depicted as 103 in FIGS. 1 and 2A) may include, as depicted in FIG. 4B, a wicking tube 403 with a sintered wick 405 deposited on the inside of the tube wall such that the gas and ions moving through the open center 407 of the tube mix with the evaporated solvent entering radially from the wick. In some embodiments, the wicking tube 403 may comprise solid copper, and the sintered wick 405 may comprise porous copper. FIG. 4C depicts one example of the components of the exemplary system of FIG. 2A including the exemplary tubing of FIG. 4B. As depicted in FIG. 4C, the system includes a heater 121 configured to supply heat to the wick such that evaporation of the solvent is amplified.

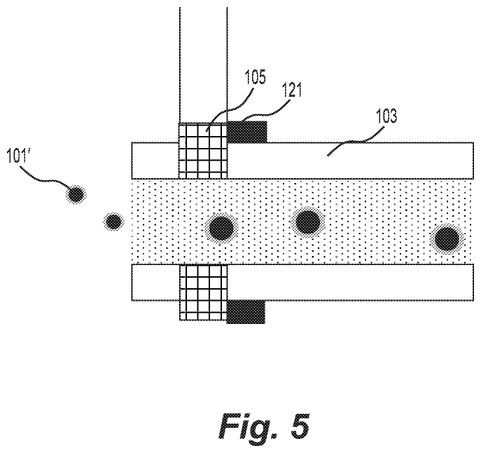

In some embodiments, the ion source may comprise a source that produces ions that form droplets by the very nature of the ionization process, e.g., ESI or DESI. Such embodiments may further include a wick evaporator adapted to enlarge the clusters. FIG. 5 depicts such an ion source. In FIG. 5, droplets 101′ enter tube 103 rather than ions 101. Droplets 101′ are then enlarged by, for example, evaporator 105, which may include heater 121.

In some embodiments, the ESI clusters may already contain sufficient molecules to experience the thermophoretic effect. In such embodiments, the transfer tube assembly may be simplified by removal of the heated wick while retaining heating of the transfer tube wall.

1. A system for transferring ions to a mass spectrometer, comprising:
an ion source;
a device for generating a solvent vapor;
a device for mixing the ions and the vapor, wherein the mixing causes solvent clusters to nucleate on the ions; and a transfer tube coupled to the mass spectrometer,
wherein the transfer tube couples the ion source and the mass spectrometer, wherein the transfer tube is configured to transfer the ions by using a gas flow and prevent the solvent clusters from contacting the tube wall by using thermophoresis.

2. The system of claim 1, further comprising:
a heater located at the end of the transfer tube, wherein the heater liberates the ions from the solvent clusters.

3. The system of claim 1, wherein the ion source includes at least one of:
atmospheric-pressure chemical ionization, low-temperature plasma ionization, dielectric barrier discharge, and flowing atmospheric-pressure afterglow.

4. The system of claim 1, wherein the solvent has a permanent dipole moment equal or greater than the dipole moment of water.

5. The system of claim 1, wherein the transfer tube is configured to allow the gas to expansively cool as it flows through the transfer tube and thereby create a temperature gradient for the thermophoresis.

6. The system of claim 1, wherein the transfer tube is configured to cause the gas to expand before entering the tube.

7. The system of claim 6, wherein the expansive cooling of the gas occurs in a substantially straight section of tubing.

8. The system of claim 6, further comprising:
a nozzle located before the transfer tube and configured to cause the gas to expand before entering the tube,
wherein the nozzle comprises at least one of: a diverging nozzle or a converging-diverging nozzle.

9. The system of claim 1, wherein the walls of the transfer tube are heated.

10. The system of claim 9, wherein the walls of the transfer tube wall are heated to increasing temperatures from the ion source to the mass spectrometer.

11. The system of claim 1, wherein the transfer tube includes one or more curves, and wherein the walls of the transfer tube before and after the one or more curves are heated.

12. The system of claim 1, where the mixing device includes a diverging nozzle.

13. The system of claim 1, where the mixing device includes a section of constant diameter tubing configured to cause the solvent clusters to nucleate on the ions.

14. The system of claim 13, wherein the constant diameter tubing has a diameter smaller than the diameter of the transfer tube.

15. The system of claim 13, wherein the nucleation occurs along at least a portion of the length of the transfer tube.

16. The system of claim 1, wherein the solvent vapor generating device comprises a sintered metal wick in contact with a solvent reservoir.

17. The system of claim 16, wherein the wick is located at the end of the inlet to the transfer tube.

18. The system of claim 16, wherein the wick is located near the middle of the inlet to the transfer tube, where the pressure is below atmosphere.

19. The system of claim 17, wherein the solvent vapor generating device evaporates the solvent by heating the wick.

20. The system of claim 1, wherein the gas flow becomes turbulent in at least part of the transfer tube.

21. The system of claim 1 wherein the transfer tube is between 20 cm and 100 cm long.

22. A system for the transfer of ions, comprising:
an ion source for generating ions;
an aerosol generating device for generating aerosol;
a device for mixing the ions and the aerosol, wherein the mixing causes charged aerosol clusters to form; and a transfer tube,
wherein the transfer tube couples the ion source and a destination for the ions, and
wherein the transfer tube is configured to transfer the ions by using a gas flow and prevent the charged aerosol clusters from contacting the tube wall by using thermophoresis.

23. The system of claim 22, wherein the aerosol generating device comprises an ultrasonic nebulizer.

24. The system of claim 23, wherein the aerosol generating device generates aerosol using a Venturi effect.

25. The system of claim 1, wherein the ion source, the solvent vapor generating device, and the mixing device include at least one of: an electrospray ionization (ESI) source, or a paper spray ionization source.

26. The system of claim 1, where the ion source, the solvent vapor generating device, and the mixing device comprise at least one of: an Extractive ESI (EESI) source, a Desorption ESI (DESI) source, or a Laser Ablation ESI (LAESI) source.
